(19) United States
(12) Patent Application Publication
(10) Pub. No.: US 2005/0001903 A1
(43) Pub. Date: Jan. 6, 2005

(54) Methods and apparatuses for displaying and rating content

(76) Inventors: Sean Christopher Endler, San Francisco, CA (US); Hiroshi Yasutomi, Tokyo (JP)

Correspondence Address: Valley Oak Law;#106, 5655 Silver Creek Valley Road, San Jose, CA, 95138, US

(21) Appl. No.: 10/820,338

(22) Filed: Apr. 7, 2004

Related U.S. Application Data
(60) Provisional application No. 60/484,282, filed on Jul. 2, 2003.

(51) Int. Cl. H04N 7/173

(52) U.S. Cl. 348/207.1

(57) ABSTRACT

In one embodiment, the methods and apparatuses receive content; create profile information associated with the content; show the content on a display device; receive a vote on the content; and update the profile information associated with the content to reflect the vote.

### CROSS REFERENCE TO RELATED APPLICATIONS

The present application claims benefit of U.S. Provisional Patent Application No. 60/484,282 filed on Jul. 2, 2003, entitled “Gear-on”, the disclosure of which is hereby incorporated by reference.

### FIELD OF THE INVENTION

The present invention relates generally to displaying and rating content and, more particularly, to interactively displaying and rating content.

### BACKGROUND

There are many personal video cameras in use. With the increase in quality of personal video cameras and decrease in cost and size of these cameras, it is getting easier and cheaper for individuals to capture high quality video footage of events detailing their lives. For example, many users capture traditional events such as vacations, birthdays, and weddings with their video cameras. With the increase in portability of modern personal video cameras, users are also capturing video footage of their hobbies that reflect their active lifestyles such as skiing, mountain climbing, mountain biking, kayaking, sky-diving, and the like.

With the increase in use of personal video cameras, there is an increasing amount of video footage recorded by users. Although potentially more video footage is captured, the amount of time and desire dedicated to spend viewing the captured video footage does not necessarily increase.

### SUMMARY

In one embodiment, the methods and apparatuses receive content; create profile information associated with the content; show the content on a display device; receive a vote on the content; and update the profile information associated with the content to reflect the vote.

### BRIEF DESCRIPTION OF THE DRAWINGS

The accompanying drawings, which are incorporated in and constitute a part of this specification, illustrate and explain one embodiment of the methods and apparatuses for displaying and rating content. In the drawings,

FIG. 1 is a diagram illustrating an environment within which the methods and apparatuses for displaying and rating content are implemented;

FIG. 2 is a simplified block diagram illustrating one embodiment in which the methods and apparatuses for displaying and rating content are implemented;

FIG. 3 is a simplified block diagram illustrating a system, consistent with one embodiment of the methods and apparatuses for displaying and rating content;

FIG. 4 illustrates an exemplary record for use with the methods and apparatuses for displaying and rating content;

FIG. 5 is a diagram illustrating an environment within which the methods and apparatuses for displaying and rating content are implemented;

FIG. 6 is a flow diagram consistent with one embodiment of the methods and apparatuses for displaying dynamic content through a device;

FIG. 7 is a flow diagram consistent with one embodiment of the methods and apparatuses for displaying and rating content; and

FIG. 8 illustrates an exemplary device consistent with one embodiment of the methods and apparatuses for displaying and rating content.

### DETAILED DESCRIPTION

The following detailed description of the methods and apparatuses for displaying and rating content refers to the accompanying drawings. The detailed description is not intended to limit the methods and apparatuses for displaying and rating content. Instead, the scope of the methods and apparatuses for displaying and rating content are defined by the appended claims and equivalents. Those skilled in the art will recognize that many other implementations are possible, consistent with the present invention.

References to “content” includes textual data, graphical data, video footage, digital images, audio data, and the like.

References to “audience” refers to at least one person viewing the content.

In one embodiment, the methods and apparatuses for displaying and rating content allow content to be captured, the content to be viewed by an audience, the content to be rated by the audience, the content to be automatically selected based on the ratings of the content by the audience, and the selected content to be viewed by the audience.

Further, in one embodiment, the methods and apparatuses for displaying and rating content is capable of separating a string of content such as video footage into separate video segments. In one embodiment, the content is streamed in real time to be viewed by the audience as the content is captured.

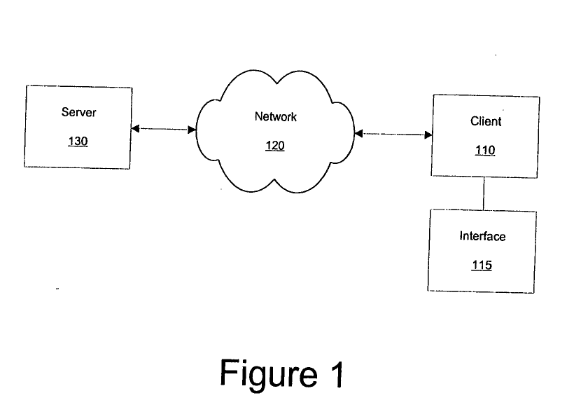

FIG. 1 is a diagram illustrating an environment within which the methods and apparatuses for displaying and rating content are implemented. The environment includes an electronic device 110 (e.g., a digital camera, a video camera, an audio recorder, a computer, a personal digital assistant, and the like), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces such as a display and speakers in the same housing. In one embodiment, the user utilizes interface 115 to access and control content and applications stored in electronic device 110, server 130, or a remote storage device (not shown) coupled via network 120.

In accordance with the invention, embodiments of displaying and rating content below are executed by an electronic processor in electronic device 110, in server 130, or by processors in electronic device 1 10 and in server 130 acting together. Server 130 is illustrated in FIG. 1 as being a single computing platform, but in other instances are two or more interconnected computing platforms that act as a server.

In one embodiment, the electronic device 110 is a content capturing device such as a digital camera, a video camera, and an audio recorder. The content capturing device is utilized to capture content. In another embodiment, the electronic device 110 is a voting apparatus such as a computer, personal digital assistant, a remote control, and the like. The voting apparatus is utilized to judge the content captured by the content capturing device.

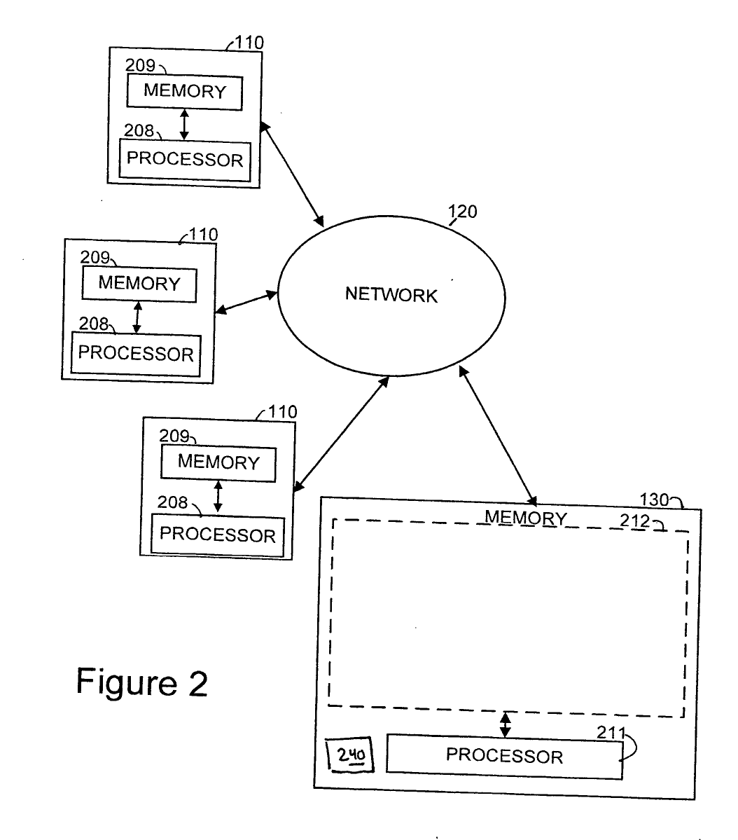

FIG. 2 is a simplified diagram illustrating an exemplary architecture in which the methods and apparatuses for displaying and rating content are implemented.

The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. In one embodiment, a unique user operates each electronic device 110 via an interface 115 as described with reference to FIG. 1.

The server device 130 includes a processor 21 1 coupled to a computer-readable medium 212. In one embodiment, the server device 130 is coupled to one or more additional external or internal devices, such as, without limitation, a secondary data storage element, such as database 240.

In one embodiment, the plurality of client devices 110 and the server 130 include instructions for a customized application for displaying and rating content. In one embodiment, the plurality of computer-readable media 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in media 209, in media 212, or a single user application is stored in part in one media 209 and in part in media 212. In one instance, a stored user application, regardless of storage location, is made customizable based on displaying and rating content as determined using embodiments described below.

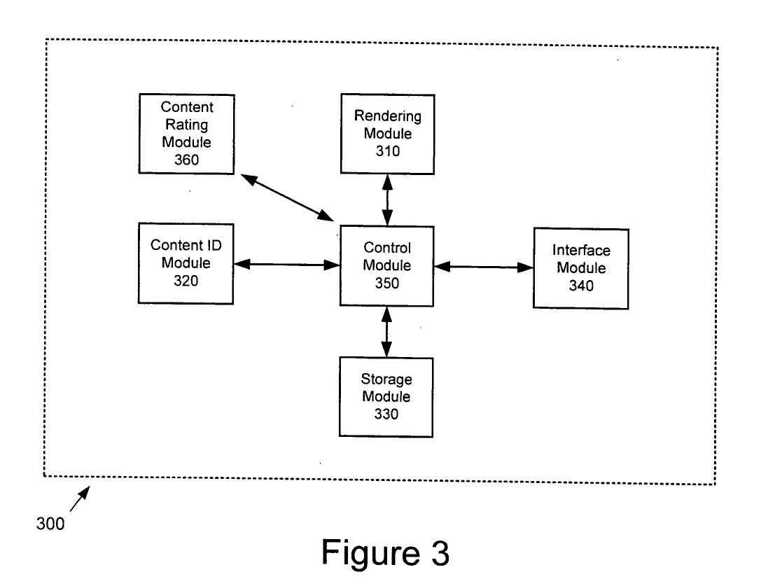

FIG. 3 illustrates one embodiment of a system 300. In one embodiment, the system 300 is embodied within the server 130. In another embodiment, the system 300 is embodied within the electronic device 110. In yet another embodiment, the system 300 is embodied within both the electronic device 110 and the server 130.

In one embodiment, the system 300 includes a rendering module 310, a content identification module 320, a storage module 330, an interface module 340, a control module 350, and a content rating module 360.

In one embodiment, the control module 350 communicates with the rendering module 310, the content identification module 320, the storage module 330, the interface module 340, and the content rating module 360. In one embodiment, the control module 350 coordinates tasks, requests, and communications between the rendering module 310, the content identification module 320, the storage module 330, the interface module 340, and the content rating module 360.

In one embodiment, the rendering module 310 produces signals that present content to an audience. In one embodiment, the signals represent content such as audio data, image data, and a combination of audio/video data.

In one embodiment, the content identification module 320 identifies the content. In one embodiment, the content identification module 320 assigns a unique identifier to each piece of content. For example, the unique identifier is a descriptive name of the content in one embodiment.

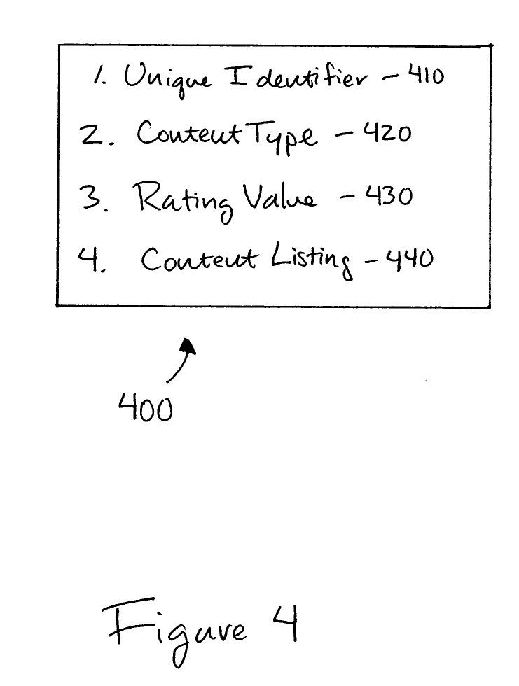

Further, the content identification module 320 also separates a group of content containing multiple pieces of content into separate pieces. For example, in video footage, multiple video segments are serially recorded and are separated by the start/stop signal. In one embodiment, the content identification module 320 detects the start/stop signal and separates each video segment as a different piece of content. For example, the start/stop signal corresponds to the use of the video camera record button and is translated into “in and out points” In one embodiment, each piece of content is associated with a record. This record stores additional information corresponding to the particular piece of content. An exemplary record is shown in FIG. 4. In one embodiment, the record corresponding to particular pieces of content identifies new “in and out points” within the original “in and out points” derived from depressing the record button. Multiple “in and out points” are established within any given clip or video footage.

In one embodiment, the storage module 330 stores a record including information associated with a particular piece of content. An exemplary embodiment of the information contained within the record associated with the content is illustrated in FIG. 4.

In one embodiment, the interface module 340 receives a signal from one of the electronic devices 110 transmitting the content to the system 300. In this embodiment, the electronic device 110 is either a content capturing device or a content storage device.

In another embodiment, the interface module 340 transmits rendering information from the rendering module 310 to present the content to an audience.

In yet another embodiment, the interface module 340 receives a rating of the content from the audience. In one embodiment, the rating is received through input from the audience via one of the electronic devices 110.

In one embodiment, the content rating module 360 receives the rating from the audience regarding a particular content. In one embodiment, the content rating module 360 assigns a rating value for the particular content based on the rating from the audience. In another embodiment, multiple viewers comprise the audience for a particular content and the rating value is an average of the ratings from multiple viewers. In one embodiment, the rating value is attached to the corresponding piece of content as metadata and is shown as a profile information in FIG. 4.

In one embodiment, the rating value is utilized to determine the quality of the content. For example, when the rating value for a particular content is above a predetermined threshold, then the particular content is considered being of good quality. Similarly, when the rating value for the particular content is below the predetermined threshold, then the particular content is considered being of poor quality. The rating value establishes “in and out points” with a quantifiable significance. In one embodiment, the quantifiable significance relates to the quality of the footage. Other types of significance can be applied to the same method.

In one embodiment, content that is considered good quality is shown again to the audience in the form of a collection of good quality content. Further, the good quality content is also archived and stored within the storage module 330. In one embodiment, content that is considered bad quality is not shown again. Further, the bad quality content is removed from the storage module 330 to make room for additional content.

The system 300 in FIG. 3 is shown for exemplary purposes and is merely one embodiment of the methods and apparatuses for displaying and rating content. Additional modules may be added to the system 300 without departing from the scope of the methods and apparatuses for displaying and rating content. Similarly, modules may be combined or deleted without departing from the scope of the methods and apparatuses for displaying and rating content.

FIG. 4 illustrates an exemplary record 400 identifying profile information corresponding to a particular piece of content for use with the methods and apparatuses for displaying and rating content. In one embodiment, there are multiple records such that each record 400 is associated with a particular piece of content. In one embodiment, the record 400 is stored as metadata for the corresponding content. In one embodiment, the record 400 includes a unique identifier field 410, a content type field 420, a rating value field 430, and a content listing field 440.

In one embodiment, the unique identifier field 410 uniquely identifies the content. In one example, a descriptive name is utilized to identify the content such as Uncle Bob's 50^{th} Birthday.

In one embodiment, the content type field 420 identifies the type of content associated with the particular content. For example, exemplary content types include video, audio, image, and the like.

In one embodiment, the rating value field 430 identifies the rating value for the particular content. In one embodiment, the rating value is derived from the rating for the particular content from the audience. In one embodiment, the audience rates the content as the content is viewed by the audience.

In one embodiment, the content listing field 440 identifies the different pieces that utilize the particular content. For example, if the particular content is utilized within a production containing multiple pieces of content, then the content listing field 440 references this production. An exemplary production that contains multiple pieces of content is entitled “A Collection of the Best Ski Jumps”.

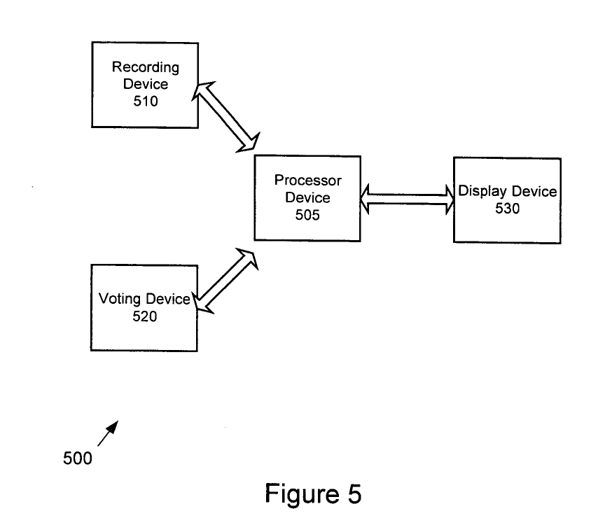

FIG. 5 illustrates one embodiment of a system 500 for displaying and rating content. The system 500 includes a recording device 510, a voting device 520, a processor device 505, and a display device 530. In one embodiment, the recording device 510, the voting device 520, and the display device 530 are representative of the electronic device 110. Further, the processor device 505 is representative of the server 130.

In one embodiment, the recording device 510 transmits content captured by the recording device 510 to the processor device 505. In one embodiment, the content is transmitted to wirelessly to the processor device 505. In one embodiment, the recording device 510 is a video camera. In another embodiment, the recording device 510 is a digital camera, an audio recorder, or the like.

Once the processor 505 receives the content, the processor 505 instructs the display device 530 to show the content to the audience in one embodiment. Upon viewing the content, the audience rates the content through the voting device 520. In one embodiment, the voting happens in real time as the content is being watched. In one embodiment, real time voting utilizes a buffer to compensate for the time lag between viewing the correct segment and applying the vote to the correct segment of content (before, during, or after the actual event of button press). In one embodiment, the voting device 520 transmits the rating value of the content to the processor 505. The rating value is the score determined by the audience with respect to the content.

In one embodiment, if there are multiple viewers in the audience, there are also multiple rating values for each piece of content. The processor 505 averages the rating values and assigns the particular content with a rating value.

Based on the rating values of each piece of content, the processor 505 orders the content based on the rating values and transmits the best content to the display device 530 to show the audience.

In one embodiment, the voting device 520 and the display device 530 are the same device that are capable of performing both functions such as a computer, personal digital assistant, cellular phone, and the like.

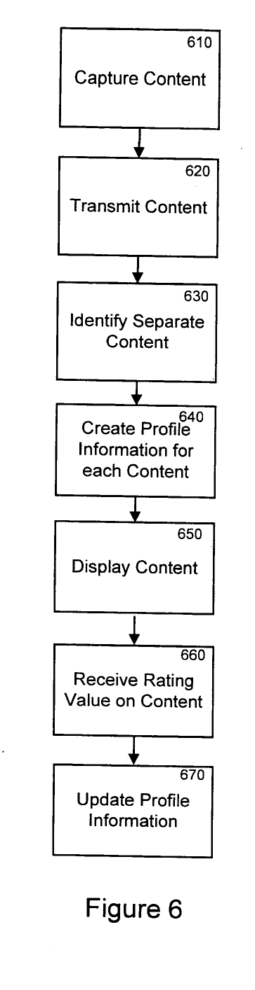

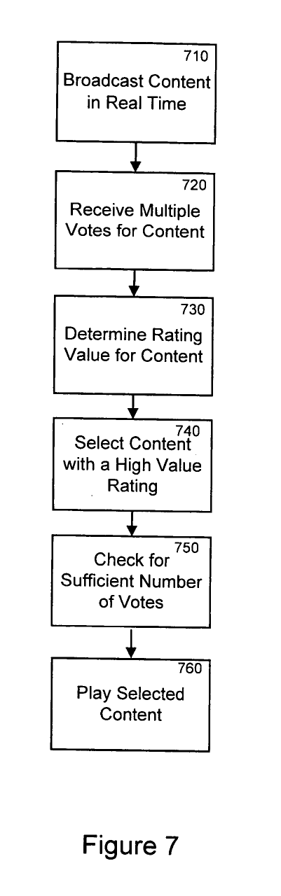

The flow diagrams as depicted in FIGS. 6 and 7 are one embodiment of the methods and apparatuses for displaying and rating content. The blocks within the flow diagrams can be performed in a different sequence without departing from the spirit of the methods and apparatuses for displaying and rating content. Further, blocks can be deleted, added, or combined without departing from the spirit of the methods and apparatuses for displaying and rating content.

The flow diagram in FIG. 6 illustrates an exemplary application of the methods and apparatuses for displaying and rating content. This exemplary application illustrates utilizing the electronic device as a content capturing device to capture content. Further, the application also utilizes another electronic device as a voting device to receive a rating value from a viewer in response to the content.

In Block 610, a content capturing device records content in one embodiment. The content capturing device includes devices such as audio recorders, video cameras, digital cameras, and the like. The content includes audio data, video footage, and digital images. In an alternative embodiment, the content capturing device is substituted for a storage device such as a computer and a hard drive that is capable of storing the content.

In Block 620, the content is transmitted from the content capturing device to a processor device such as the processor device 505. In one embodiment, the content capturing device transmits the content to the processor device 505 via a wired connection such as Ethernet, Firewire, USB, and the like. In another embodiment, the content is transmitted to the processor device 505 via a wireless connection such as a cellular network, microwave transmission, WiFi protocol, Ultra Wideband protocol, ISM Band protocol, and Bluetooth protocol.

In one embodiment, the content is streamed to the processor device 505 in real time as the content is captured by the content capturing device. In another embodiment, the content is transmitted to the processor device 505 in blocks after the content has been captured by the content capturing device.

In Block 630, multiple pieces of content are identified. For example, when capturing video footage, separate segments of video footage are often captured and can resemble continuous video footage.

In one embodiment, the processor device 505 identifies the separate, different video segments from video footage. The start/stop record button on the video camera starts and stops the capture of content by the video camera and creates distinct segments of the overall video footage. The processor device 505 detects a signal corresponding to the use of the start/stop button and determines the different segments of the video footage.

In Block 640, profile information is created for each piece of content. For example, each video segment includes a corresponding profile information. In one embodiment, the profile information is stored within the storage module 330. An exemplary record showing the profile information is included in FIG. 4.

In Block 650, the content is displayed. In one embodiment, the processor device 505 instructs the display device 530 to display the content. In one embodiment, an audience views the content displayed on the display device 530.

In Block 660, a rating value is received for the content. In one embodiment, the audience provides the rating value for the content through the voting device 520. In one embodiment, the rating value is assigned to a particular content based on the timing of the rating value being received. For example, if the rating value is received while the particular content is being displayed, then the rating value corresponds with the particular content. In another example, the display device 530 indicates the particular piece of content associated with the rating value provided by the audience.

In one embodiment, the rating value indicates the popularity of the content by the audience. For example, the higher the rating value for a particular content indicates that the particular content is more popular among the audience. Further, the popularity of the content is placed into additional categories such as stunts, jumps, bloopers, and the like. In Block 670, the profile information is updated based on the rating value assigned to the particular content.

The flow diagram in FIG. 7 illustrates an exemplary application of the methods and apparatuses for displaying and rating content. This exemplary application illustrates utilizing the electronic device as a content capturing device to capture content. Further, the application also utilizes another electronic device as a voting device to receive a rating value from multiple viewers in response to the content.

In Block 710, content is broadcasted and seen by multiple viewers in real time as the content is captured. In one embodiment, there is an amount of lag time between the time the content being captured and the time the content is displayed for multiple viewers. In one embodiment, the content is video footage that is streamed to the multiple viewers. In one embodiment, the multiple viewers are located in a single location. In another embodiment, each viewer is located in a different location.

In Block 720, a vote is received from each of the viewers rating the quality of the content.

In Block 730, the rating value for the content is determined. In one embodiment, the rating value is determined based on the votes received from each of the viewers regarding the content. For example, if different votes rate the quality of the content at different levels, then an average rating value is computed based on the votes.

In Block 740, content that receives a value rating above a predetermined value rating threshold is selected. For example, if the content has a value rating above the predetermined threshold, then this content is selected.

In one embodiment, the predetermined value rating threshold is based on a minimum standard. For example, if the value rating for the content is based on a score of 1 to 10 with 10 being the highest, the predetermined value rating threshold can be set at 7 in one embodiment.

In another embodiment, the predetermined value rating threshold is set based on a percentage of the overall number of content. For example, the predetermined value rating threshold is set so that 10% of the content is selected. In this example, based on the value rating of each piece of content, the top 10% of the content is selected.

In Block 750, a check is performed to ensure that each piece of content receives a sufficient number of votes to reach a predetermined level. For example, if the number of votes falls short of the predetermined level, then the sample size of the votes is not large enough to compute the rating value for the content.

In Block 760, the selected content is displayed to the viewers.

In use, an exemplary application of the methods and apparatuses for displaying and rating content includes video footage captured from multiple participants of an event such as skiing. In this application, the participants are captured skiing with video footage. In one embodiment, the participants are skiing at the same ski resort. In another embodiment, the participants are skiing at different locations.

In this application, the video footage of each participant is transmitted to a processor device. In one embodiment, the video footage is streamed to the processor device in substantially real time. In another embodiment, the video footage is temporarily stored on the video camera device prior to transmission to the processor device.

The video footage from various participants is displayed to an audience that can judge the quality of the video footage by voting on the corresponding video footage. In one embodiment, the audience includes multiple viewers in a sports bar within the ski resort where the participants are located. In this embodiment, the viewers may know the participants and are able to see the participants skiing on the local terrain and are able to vote for the best video footage. In another embodiment, the audience includes multiple viewers located at a bar in a remote location relative to the ski resort where the participants are located. In yet another embodiment, the audience includes multiple viewers located in different locations and receiving the video footage through the Internet.

Based on the votes for each video footage, the best video footage are selected to be shown the audience. For example, the viewers are gathered at the sports bar and see the various segments of video footage. As the viewers watch the various segments of video footage, they also vote for their favorite segments. Based on the votes by the viewers, the most popular segments of video footage are selected and displayed to the viewers.

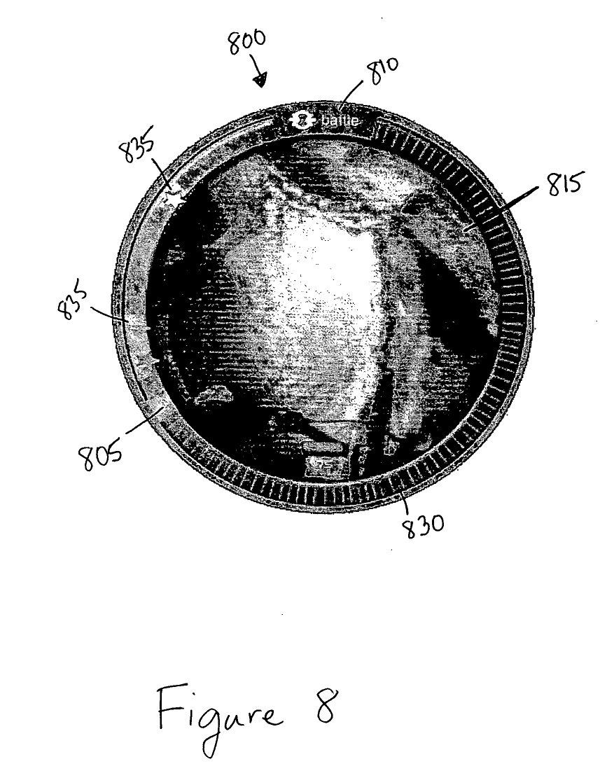

FIG. 8 illustrates a display system 800 that displays the content to the audience. In one embodiment, the content is streamed to the display system 800 in real time as the content is being captured. In another embodiment, the content is transmitted to the display system 800 after the content has been captured.

In one embodiment, the display system 800 includes a playback head 805, an information display 810, a display area 815, a playback ring 830, and a rating value icon 835.

In one embodiment, the display area 815 shows the content to the viewer. Further, the information display 810 identifies the content shown within the display area 815.

In one embodiment, the playback ring 830 graphically represents the length of the content such that each portion of the playback ring 830 represents a portion of the content that is identified within the information display 810. The playback head 805 represents the specific portion of the content that is currently displayed within the display area 815. As the content is displayed, the playback head 805 moves in a counter-clockwise direction such that content associated with the playback ring 830 in the clockwise direction relative to the playback head 805 has either already been viewed or is chronologically behind the playback head 805. Similarly, content associated with the playback ring 830 in the counter-clockwise direction relative to the playback head 805 has either not been viewed yet or is chronologically ahead of the playback head 805.

In one embodiment, the rating value icon 835 graphically illustrates the rating value assigned to a portion of the content. The rating value icon 835 is shown along the playback ring 830 to represent a rating value for a specific portion of the content such as the “in and out points” of that rated piece. In one embodiment, the rating value icon 835 represents a specific rating value based on the color of the icon 835, the symbol of the icon 835, and the like. For example, a gold color is shown on the icon 835 when the rating value is the highest. In another example, a number is shown as the icon 835 to denote the rating value with a higher number representing a higher rating.

In another embodiment, as the content is re-played through the display system 800 after being rated, the rating value icon 835 is displayed on the playback ring 830 prior to the playback head 805 (in the counter-clockwise direction relative to the playback head 805) such that prior rating values are shown through the rating value icon 835 prior to replaying that portion of the content.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A method comprising:
receiving content;
creating profile information associated with the content;
showing the content on a display device;
receiving a vote on the content; and
updating the profile information associated with the content to reflect the vote.

2. The method according to claim 1 further comprising storing the profile information associated with the content within a storage device.

3. The method according to claim 1 further comprising capturing the content with a content capturing device.

4. The method according to claim 3 wherein the content capturing device is a video camera.

5. The method according to claim 3 wherein the content capturing device is a digital camera.

6. The method according to claim 3 wherein the content capturing device is an audio recorder.

7. The method according to claim 1 identifying the content from multiple pieces of content.

8. The method according to claim 1 wherein receiving the content occurs in real time relative to capturing the content.

9. The method according to claim 1 wherein the content is video footage.

10. The method according to claim 1 wherein the content is a digital image.

11. The method according to claim 1 wherein the content is audio data.

12. The method according to claim 1 wherein the vote includes a rating value that corresponds with the content.

13. The method according to claim 12 further comprising comparing the rating value with a predetermined value rating threshold.

14. The method according to claim 13 further comprising selectively displaying the content based on the comparing the rating value.

15. A system comprising:
means for receiving content;
means for creating profile information associated with the content;
means for showing the content on a display device;
means for receiving a vote on the content; and
means for updating the profile information associated with the content to reflect the vote.

16. A method comprising:
identifying content;
creating profile information associated with content;
showing the content to a plurality of viewers;
receiving a vote on the content from each of the plurality of viewers;
determining a rating value for the content based on the vote; and
displaying the content to the plurality of viewers based on the rating value of the content.

17. The method according to claim 16 further comprising updating the profile information associated with the content to reflect the rating value.

18. The method according to claim 16 further comprising checking for a number of viewers submitting the vote.

19. The method according to claim 18 further comprising comparing the number of viewers with a predetermined minimum number of votes.

20. The method according to claim 16 further comprising storing the profile information.

21. A device, comprising:
a content identification module to detect content;
a storage module to store the content and a profile information associated with the content;
an interface module for receiving the content and transmitting the content based on the profile information corresponding to the content; and
a content rating module receives a rating value from a viewer for the content and updates the profile information associated with the content.

22. The system according to claim 21 wherein the content includes one of a video footage, digital image, and audio data.

23. The system according to claim 21 further comprising a rendering module for formatting the content to be displayed to the viewer.

24. The system according to claim 21 further comprising a rendering module for selectively formatting the content for display to the viewer based on the rating value associated with the content.

25. A computer-readable medium having computer executable instructions for performing a method comprising:
identifying content;
creating profile information associated with content;
showing the content to a plurality of viewers;
receiving a vote on the content from each of the plurality of viewers;
determining a rating value for the content based on the vote; and
displaying the content to the plurality of viewers based on the rating value of the content.
